(19) United States
(12) Patent Application Publication
(10) Pub. No.: US 2010/0051759 A1
(43) Pub. Date: Mar. 4, 2010

(54) Wiring holding flange and manufacturing method thereof

(75) Inventor: Kwang Il NOR, Gunpo-si (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/494,067

(22) Filed: Jun. 29, 2009

(30) Foreign Application Priority Data
Aug. 29, 2008 (KR) 10-2008-0085074

(51) Int. Cl. F16L 3/08; B21D 43/28

(52) U.S. Cl. 248/67.7; 72/324

(57) ABSTRACT

A flange for holding a wiring or hose arranged on a chassis panel, may include a pair of connecting portions integrally formed on a bottom surface of the chassis panel, wherein the pair of the connecting portions are spaced with a predetermined distance each other, bent portions formed upwards from the connecting portions and bent in receding direction from each other and then in approaching direction to each other to hold the wiring or hose therein, and/or support portions formed on upper end portions of the bent portions to guide the wiring or hose into the bent portions and prevent release of the wiring or hose therefrom.

### CROSS-REFERENCE TO RELATED APPLICATION

The present application claims priority to Korean Patent Application Number 10-2008-0085074 filed Aug. 29, 2008, the entire contents of which application is incorporated herein for all purposes by this reference.

### BACKGROUND OF THE INVENTION

1. Field of the Invention

The present invention relates to a flange for holding wiring and a manufacturing method thereof, and more particularly, to a wiring holding flange integrally formed with a chassis panel and a method of easily manufacturing the same.

2. Description of Related Art

In general, various wiring, hoses, and tubes are complicatedly arranged in a vehicle, and are fixed to a chassis of the vehicle by holders such as a bracket, a clamp or a clip in order to prevent the wiring, hoses, and tubes from being swayed or released.

FIGS. 1 to 3 are perspective views illustrating a conventional clip for holding a wiring in a vehicle.

A conventional wiring holding clip 10 for a vehicle includes, as shown in FIGS. 1 to 3, a circular holder portion 12 with an opened portion to hold a wiring or hose 1 therein, and a fastener portion 11 coupled to a lower portion of the holder portion 12 and fastened to a chassis of the vehicle so as to connect the holder portion 12 to a chassis panel 30.

The wiring or hose 1 can be effectively held by inserting the wiring holding clip 10 for holding the wiring or hose 1 into a hole formed in the chassis panel 30. Since the wiring holding clip 10 should be separately bought, additional expenses are incurred. In particular, preparation of wiring holding clip 10 of various sizes for sizes of the wiring or hoses 1 incurs significant expenses.

In order to solve the above problem, Korean Patent Unexamined Publication No. 1997-0040209 entitled “Washer hose holding structure” is disclosed.

The washer hose holding structure disclosed in the publication is to directly attach a washer hose to a reinforcing plate of a bonnet, without using additional holder clip.

More specifically, the washer hose holding structure is a reinforcing plate for the bonnet which is welded to a bottom surface of an outer panel of the bonnet. The washer hose holding structure includes a flexible flange integrally formed with the reinforcing plate of the bonnet in order to receive a circular washer hose.

Since the flange integrally formed with the reinforcing plate is formed in a shape of cantilever, its durability is lowered, and its manufacturing process is complicated and difficult, which increases a manufacturing cost thereof.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide for a wiring holding flange integrally formed with a chassis panel and a method of easily manufacturing the same to lower a manufacturing cost thereof.

One aspect of the present invention, a flange for holding a wiring or hose arranged on a chassis panel, may include a pair of connecting portions integrally formed on a bottom surface of the chassis panel, wherein the pair of the connecting portions are spaced with a predetermined distance each other, bent portions formed upwards from the connecting portions and bent in receding direction from each other and then in approaching direction to each other to hold the wiring or hose therein, and/or support portions formed on upper end portions of the bent portions to guide the wiring or hose into the bent portions and prevent release of the wiring or hose therefrom.

A groove may be formed on the chassis panel between the pair of the connecting portions, for receiving the wiring or hose therein.

Opening formed between upper portions of the support portions maybe wider than that formed at lower portions of the support portions.

The flange may have a resilient force to bias the wiring or hose towards a center portion of the flange.

In another aspect of the present invention, a wiring holding wiring may include a pair of connecting portions integrally formed on a chassis panel.

In further another aspect of the present invention, a method of manufacturing a wiring holding flange may include a cutting step of cutting a portion of a chassis panel to form a pair of members, a bending step of bending the pair of members, and/or a forming step of pressing the pair of members to form the flange for holding a wiring or hose, wherein, in the forming step, a first mold member with a groove forming portion is slid between the pair of members which are subjected to the bending step, second mold members with a boss closely contacting the groove forming portion are slid towards both lateral sides of the first mold member, and then the pair of members positioned between the groove forming portion of the first mold member and the boss of the second mold members is pressed to form the flange.

In the cutting step, a portion of the chassis panel may be cut to form a pair of members in “[” and “]” shapes respectively, and in the bending step, the pair of members subjected to the cutting step are bent upwards around a connecting portion of the chassis panel.

In the cutting step, a portion of the chassis panel may be cut to form a pair of members in “(” and “)” shapes respectively, and in the bending step, the pair of members subjected to the cutting step are bent upwards around a connecting portion of the chassis panel.

In the cutting step, a portion of the chassis panel may be cut to form a pair of members in “<” and “>” shapes respectively, and in the bending step, the pair of members subjected to the cutting step are bent upwards around a connecting portion of the chassis panel.

The method may further include, between the bending step and the forming step, a forging step of machining a groove on the chassis panel between the pair of members to receive the wiring or hose therein.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view illustrating a conventional wiring holding clip for a vehicle.

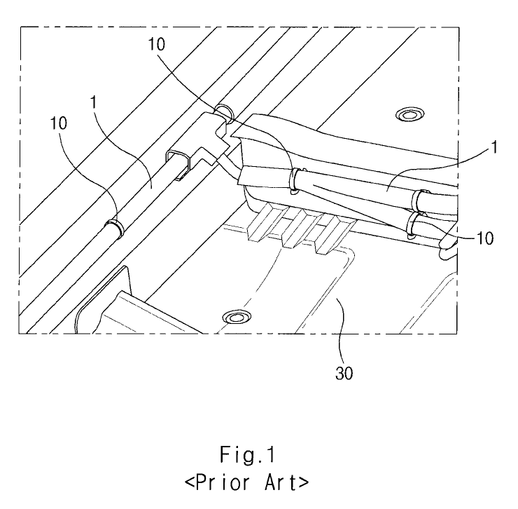

FIG. 2 is a perspective view illustrating another conventional wiring holding clip for a vehicle.

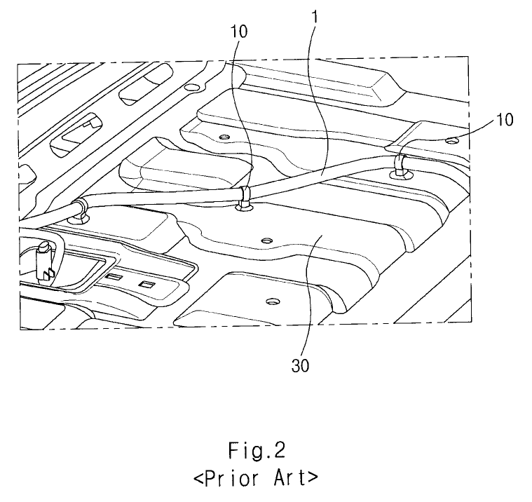

FIG. 3 is a cross-sectional view of the wiring holding clip in FIG. 2.

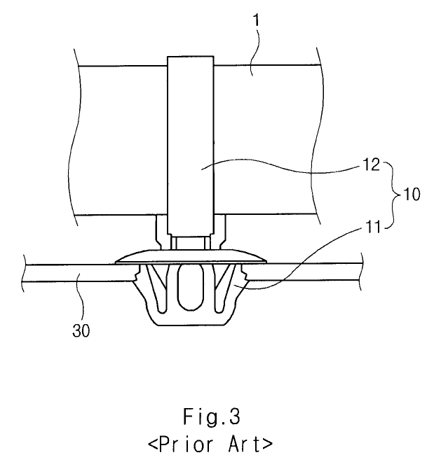

FIG. 4 is a perspective view illustrating an exemplary wiring holding flange according to the present invention.

FIG. 5 is a cross-sectional view of the wiring holding flange in FIG. 4.

FIG. 6 is a flowchart depicting an exemplary process of manufacturing a wiring holding flange according to the present invention.

FIG. 7 is a view illustrating an exemplary process of manufacturing a wiring holding flange according to the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

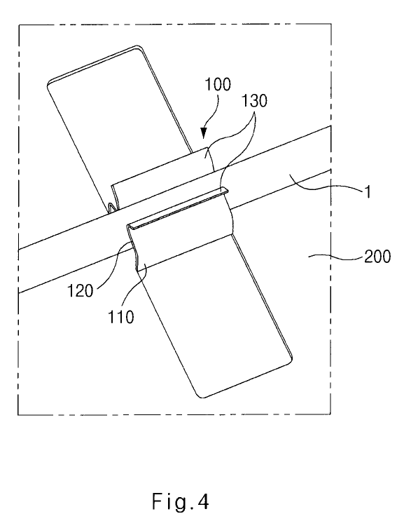

A wiring holding flange and a manufacturing method thereof according to various embodiments of the present invention will now be described in detail with reference to FIGS. 4 to 7.

A wiring holding flange 100 according to various embodiments of the present invention is to firmly hold a wiring or hose 1 arranged on a chassis panel, and is formed in a “<” and “>” shape to hold the wiring or hose 1 by the flange 100 therein.

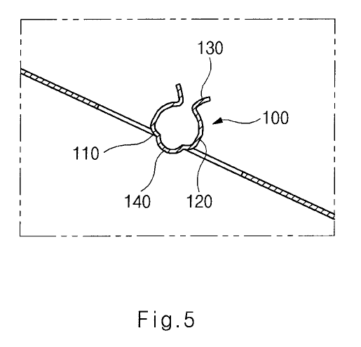

More specifically, the wiring holding flange 100 includes, as shown in FIGS. 4 and 5, a pair of connecting portions 110 integrally formed on a bottom surface of a chassis panel 200, bent portions 120 formed on the connecting portions 110 and bent in left and right directions in the drawing, i.e., in a “<” and “>” shape to hold the wiring or hose 1, and support portions 130 formed on upper portions of the bent portions 120 for guiding the wiring or hose 1 therein and preventing release of the wiring or hose 1 therefrom when the wiring or hose 1 is held.

The flange 100 including the connecting portions 110, the bent portions 120 and the support portions 130 which are integrally formed has a narrow upper portion, a wide middle portion and a narrow lower portion.

With this configuration, the wiring or hose 1 is easily inserted from the upper portion to the lower portion of the wiring holding flange 100, and after the wiring or hose 1 is mounted, it is firmly held by the flange 100 in a left or right direction to prevent release of the wiring or hose 1.

A center bottom surface between the pair of the connecting portions 110 of the flange 100 is provided with a groove 140 for receiving the wiring or hose 1 therein, so that the groove 140 prevents movement of the wiring or hose 1.

Preferably, the flange 100 has a resilient force to bias the wiring or hose 1 towards a center portion thereof, thereby preventing the movement of the wiring or hose 1.

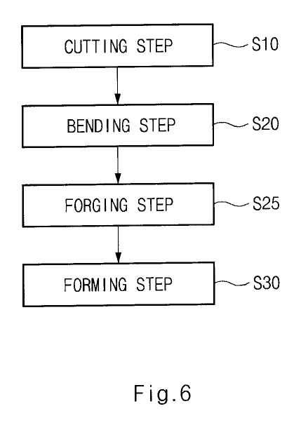

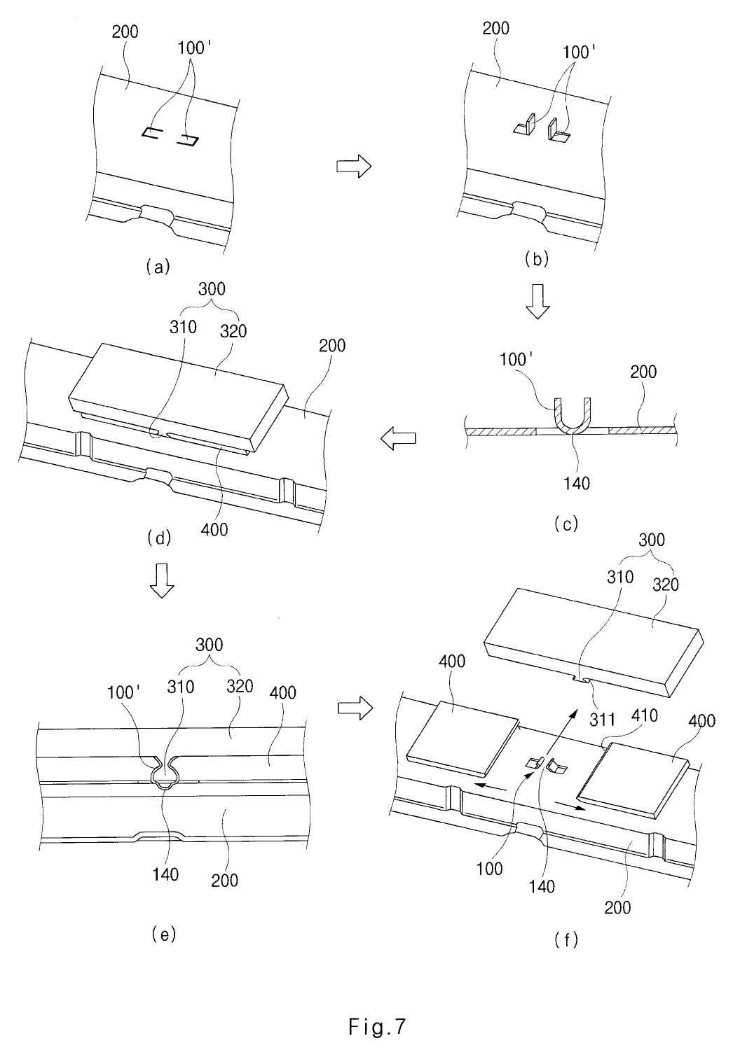

A process of manufacturing the wiring holding flange according to various embodiments of the present invention will now be described with reference to FIGS. 6 and 7.

The process of manufacturing the wiring holding flange according to various embodiments of the present invention includes a cutting step S10, a bending step S20, and a forming step S30. A forging step S25 may be provided between the bending step S20 and the forming step S30.

A. Cutting Step (S10)

The cutting step 10 is to cut a portion of the chassis panel in a certain shape.

More specifically, a portion of the chassis panel 200, on which the wiring or hose 1 is disposed, is cut to form a pair of members 100′ in “[” and “]” shapes in accordance with a size of the flange 100 to be manufactured (see FIG. 7a).

The pair of members 100′ are not limited to the “[” and “]” shapes, and may be formed in “<” and “>” shapes or in “(” and “)” shapes in accordance with a position of the flange.

B. Bending Step (S20)

The bending step S20 is to bend upwards the pair of members 100′ cut in the cut step around a portion which is integrally formed with the chassis panel 200 (see FIG. 7b).

C. Forging Step (S25)

The forging step S25 is to machine the groove 140 for receiving the wiring or hose 1 therein.

More specifically, a portion of the chassis panel 200 between the pair of members 100′ is pressed downwards by using a pressing machine such as presser to form the groove 140 having a certain depth between the pair of members 100′, so that the wiring or hose 1 can be easily seated on the groove 140 (see FIG. 7c).

D. Forming Step (S30)

The forming step S30 is to form the flange 100 for holding the wiring by horizontally pressing the pair of members 100′ which are subjected to the forging step S25.

More specifically, a first mold member 300 with a groove forming portion 311 is slid between the pair of members 100′ which are subjected to the forming step S30 or the forging step S25 (see FIG. 7d), and then second mold members 400 with a boss 410 closely contacting the groove forming portion 311 are slid towards both lateral sides of the first mold member 300. The pair of members 100′ positioned between the groove forming portion 311 of the first mold member 300 and the bosses 410 of the second mold members 400 are pressed horizontally to form the flange 100 (see FIG. 7e).

The first mold member 300 includes a vertical portion 310 with the groove forming portions 311 formed on both lateral sides thereof in a shape of flange 100, and a horizontal portion 320 formed on the upper surface of the vertical portion 310. Bosses 410 of the second mold member 400 are received between the horizontal portion 320 and the vertical portion 310.

After the forming step S30 is completed, the second mold members 400 and the first mold member 300 are successively removed, so that the pair of members 100′ is converted into the flange 100 for holding the wiring or hose 1 (see FIG. 7f).

By forming the flange for holding the wiring using the above manufacturing process, a flange may be formed in an undercut shape.

More specifically, if a pair of members is vertically stood on the chassis panel, it is impossible to form the flange using existing molds due to the undercut shape. However, the present invention can convert the pair of members into the flange 100 by moving the first mold member 300 and the second mold members 400 in two-way sliding manner, even though the pair of members is formed in the undercut shape.

In various aspects of the present invention, it is possible to manufacture the wiring holding flange by integrally forming the flange on the chassis panel, thereby reducing a manufacturing cost thereof.

For convenience in explanation and accurate definition in the appended claims, the terms “upper”, “lower”, “front”, and “rear” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A flange for holding a wiring or hose arranged on a chassis panel, comprising:
a pair of connecting portions integrally formed on a bottom surface of the chassis panel, wherein the pair of the connecting portions are spaced with a predetermined distance each other;
bent portions formed upwards from the connecting portions and bent in receding direction from each other and then in approaching direction to each other to hold the wiring or hose therein; and
support portions formed on upper end portions of the bent portions to guide the wiring or hose into the bent portions and prevent release of the wiring or hose therefrom.

2. The flange as claimed in claim 1, wherein a groove is formed on the chassis panel between the pair of the connecting portions, for receiving the wiring or hose therein.

3. The flange as claimed in claim 1, wherein opening formed between upper portions of the support portions is wider than that formed at lower portions of the support portions.

4. The flange as claimed in claim 1, wherein the flange has a resilient force to bias the wiring or hose towards a center portion of the flange.

5. A wiring holding wiring including a pair of connecting portions integrally formed on a chassis panel.

6. A passenger vehicle comprising the flange as claimed in claim 1.

7. A passenger vehicle comprising the flange as claimed in claim 5.

8. A method of manufacturing a wiring holding flange comprising:
a cutting step of cutting a portion of a chassis panel to form a pair of members;
a bending step of bending the pair of members; and
a forming step of pressing the pair of members to form the flange for holding a wiring or hose;
wherein, in the forming step, a first mold member with a groove forming portion is slid between the pair of members which are subjected to the bending step, second mold members with a boss closely contacting the groove forming portion are slid towards both lateral sides of the first mold member, and then the pair of members positioned between the groove forming portion of the first mold member and the boss of the second mold members is pressed to form the flange.

9. The method as claimed in claim 8, wherein in the cutting step, a portion of the chassis panel is cut to form a pair of members in “[” and “]” shapes respectively, and in the bending step, the pair of members subjected to the cutting step are bent upwards around a connecting portion of the chassis panel.

10. The method as claimed in claim 8, wherein in the cutting step, a portion of the chassis panel is cut to form a pair of members in “(” and “)” shapes respectively, and in the bending step, the pair of members subjected to the cutting step are bent upwards around a connecting portion of the chassis panel.

11. The method as claimed in claim 8, wherein in the cutting step, a portion of the chassis panel is cut to form a pair of members in “<” and “>” shapes respectively, and in the bending step, the pair of members subjected to the cutting step are bent upwards around a connecting portion of the chassis panel.

12. The method as claimed in claim 8, further comprising, between the bending step and the forming step, a forging step of machining a groove on the chassis panel between the pair of members to receive the wiring or hose therein.
